(19) United States
(12) Patent Application Publication
(10) Pub. No.: US 2014/0322968 A1
(43) Pub. Date: Oct. 30, 2014

(54) COAXIAL CABLE CONNECTOR WITH INTEGRAL RFI PROTECTION AND BIASING RING

(71) Applicant: CORNING OPTICAL COMMUNICATIONS RF LLC, Glendale, AZ (US)

(72) Inventor: Donald Andrew Burris, Peoria, AZ (US)

(73) Assignee: CORNING OPTICAL COMMUNICATIONS RF LLC, GLENDALE, AZ (US)

(21) Appl. No.: 14/259,703

(22) Filed: Apr. 23, 2014

Related U.S. Application Data
(60) Provisional application No. 61/817,043, filed on Apr. 29, 2013.

(51) Int. Cl. H01R 13/58; H01R 13/658; H01R 9/00

(52) U.S. Cl. CPC H01R 13/5825; H01R 9/00; H01R 13/658
USPC 439/578

(57) ABSTRACT

A coaxial cable connector having an inner conductor, a dielectric surrounding the inner conductor, an outer conductor surrounding the dielectric, and a jacket surrounding the outer conductor and used for coupling an end of a coaxial cable to an equipment connection port. The coaxial cable includes a coupler, a body, a post, and a biasing ring. The coupler is adapted to couple the coaxial cable connector to the equipment connection port. At least one of the coupler, the post, and the body has an integral, monolithic contacting portion to establish electrical continuity between at least two of the coupler, the body and the post. The biasing ring biases the contacting portion such that the electrical continuity is maintained regardless of the tightness of the coupling of the connector to the terminal.

### RELATED APPLICATIONS

This application claims the benefit of priority under 35 U.S.C. §119 of U.S. Provisional Application No. 61/817,043 filed on Apr. 29, 2013, the content of which is relied upon and incorporated herein by reference in its entirety.

### BACKGROUND

1. Field of the Disclosure

The technology of the disclosure relates to coaxial cable connectors and, in particular, to a coaxial cable connector that provides radio frequency interference (RFI) protection and grounding shield.

2. Technical Background

Coaxial cable connectors, such as type F connectors, are used to attach coaxial cable to another object or appliance, e.g., a television set, DVD player, modem or other electronic communication device having a terminal adapted to engage the connector. The terminal of the appliance includes an inner conductor and a surrounding outer conductor.

Coaxial cable includes a center conductor for transmitting a signal. The center or inner conductor is surrounded by a dielectric material, and the dielectric material is surrounded by an outer conductor. The outer conductor may be in the form of either or both of a conductive foil and braided sheath. The outer conductor is typically maintained at ground potential to shield the signal transmitted by the center conductor from stray noise, and to maintain continuous desired impedance over the signal path. The outer conductor is usually surrounded by a plastic cable jacket that electrically insulates, and mechanically protects, the outer conductor. Prior to installing a coaxial connector onto an end of the coaxial cable, the end of the coaxial cable is typically prepared by stripping off the end portion of the jacket to expose the end portion of the outer conductor. Similarly, it is common to strip off a portion of the dielectric to expose the end portion of the center conductor.

Coaxial cable connectors of the type known in the trade as “F connectors” often include a tubular post designed to slide over the dielectric material, and under the outer conductor of the coaxial cable, at the prepared end of the coaxial cable. If the outer conductor of the cable includes a braided sheath, then the exposed braided sheath is usually folded back over the cable jacket. The cable jacket and folded-back outer conductor extend generally around the outside of the tubular post and are typically received in an outer body of the connector. The outer body of the connector is often fixedly secured to the tubular post. A coupler is typically rotatably secured around the tubular post and includes an internally-threaded region for engaging external threads formed on the outer conductor of the appliance terminal.

When connecting the end of a coaxial cable to a terminal of a television set, equipment box, modem, computer or other appliance, it is important to achieve a reliable electrical connection between the outer conductor of the coaxial cable and the outer conductor of the appliance terminal. Typically, the goal is usually achieved by ensuring that the coupler of the connector is fully tightened over the connection port of the appliance. When fully tightened, the head of the tubular post of the connector directly engages the edge of the outer conductor of the appliance port, thereby making a direct electrical ground connection between the outer conductor of the appliance port and the tubular post. In turn, the tubular post is engaged with the outer conductor of the coaxial cable.

With the increased use of self-install kits provided to home owners by some CATV system operators has come a rise in customer complaints due to poor picture quality in video systems and poor data performance in computer/internet systems. Additionally, CATV system operators have found upstream data problems induced by entrance of unwanted radio frequency (“RF”) signals into their systems. Complaints of this nature result in CATV system operators having to send a technician to address the issue. Often times it is reported by the technician that the cause of the problem is due to a loose F connector fitting, sometimes as a result of inadequate installation of the self-install kit by the homeowner. An improperly installed or loose connector may result in poor signal transfer because there are discontinuities along the electrical path between the devices, resulting in ingress of undesired RF signals where RF energy from an external source or sources may enter the connector/cable arrangement causing a signal to noise ratio problem resulting in an unacceptable picture or data performance. In particular, RF signals may enter CATV systems from wireless devices, such as cell phones, computers and the like, especially in the 700-800 MHz transmitting range, resulting in radio frequency interference (RFI).

Many of the current state of the art F connectors rely on intimate contact between the F male connector interface and the F female connector interface. If, for some reason, the connector interfaces are allowed to pull apart from each other, such as in the case of a loose F male coupler, an interface “gap” may result. If not otherwise protected this gap can be a point of RF ingress as previously described.

A shield that completely surrounds or encloses a structure or device to protect it against RFI is typically referred to as a “Faraday cage.” However, providing such RFI shielding within given structures is complicated when the structure or device comprises moving parts, such as seen in a coaxial connector. Accordingly, creating a connector to act in a manner similar to a Faraday cage to prevent ingress and egress of RF signals can be especially challenging due to the necessary relative movement between connector components required to couple the connector to a related port. Relative movement of components due to mechanical clearances between the components can result in an ingress or egress path for unwanted RF signals and, further, can disrupt the electrical and mechanical communication between components necessary to provide a reliable ground path. The effort to shield and electrically ground a coaxial connector is further complicated when the connector is required to perform when improperly installed, i.e. not tightened to a corresponding port.

U.S. Pat. No. 5,761,053 to, teaches that “[e]lectromagnetic interference (EMI) has been defined as undesired conducted or radiated electrical disturbances from an electrical or electronic apparatus, including transients, which can interfere with the operation of other electrical or electronic apparatus. Such disturbances can occur anywhere in the electromagnetic spectrum. RFI is often used interchangeably with electromagnetic interference, although it is more properly restricted to the radio frequency portion of the electromagnetic spectrum, usually defined as between 24 kilohertz (kHz) and 240 gigahertz (GHz). A shield is defined as a metallic or otherwise electrically conductive configuration inserted between a source of EMI/RFI and a desired area of protection. Such a shield may be provided to prevent electromagnetic energy from radiating from a source. Additionally, such a shield may prevent external electromagnetic energy from entering the shielded system. As a practical matter, such shields normally take the form of an electrically conductive housing which is electrically grounded. The energy of the EMI/RFI is thereby dissipated harmlessly to ground. Because EMI/RFI disrupts the operation of electronic components, such as integrated circuit (IC) chips, IC packages, hybrid components, and multi-chip modules, various methods have been used to contain EMI/RFI from electronic components. The most common method is to electrically ground a “can” that will cover the electronic components, to a substrate such as a printed wiring board. As is well known, a can is a shield that may be in the form of a conductive housing, a metallized cover, a small metal box, a perforated conductive case wherein spaces are arranged to minimize radiation over a given frequency band, or any other form of a conductive surface that surrounds electronic components. When the can is mounted on a substrate such that it completely surrounds and encloses the electronic components, it is often referred to as a Faraday Cage. Presently, there are two predominant methods to form a Faraday cage around electronic components for shielding use. A first method is to solder a can to a ground strip that surrounds electronic components on a printed wiring board (PWB). Although soldering a can provides excellent electrical properties, this method is often labor intensive. Also, a soldered can is difficult to remove if an electronic component needs to be re-worked. A second method is to mechanically secure a can, or other enclosure, with a suitable mechanical fastener, such as a plurality of screws or a clamp, for example. Typically, a conductive gasket material is usually attached to the bottom surface of a can to ensure good electrical contact with the ground strip on the PWB. Mechanically securing a can facilitates the re-work of electronic components; however, mechanical fasteners are bulky and occupy “valuable” space on a PWB.”

Coaxial cable connectors have attempted to address the above problems by incorporating a continuity member into the coaxial cable connector as a separate component. In this regard, FIG. 1 illustrates a connector 1000 having a coupler 2000, a separate post 3000, a separate continuity member 4000, and a body 5000. In connector 1000 the separate continuity member 4000 is captured between post 3000 and body 5000 and contacts at least a portion of coupler 2000. Coupler 2000 may be made of metal such as brass and plated with a conductive material such as nickel. Post 3000 may be made of metal such as brass and plated with a conductive material such as tin. Separate conductive member 4000 may be made of metal such as phosphor bronze and plated with a conductive material such as tin. Body 5000 may be made of metal such as brass and plated with a conductive material such as nickel.

### SUMMARY

Embodiments disclosed herein include a coaxial cable connector having an inner conductor, a dielectric surrounding the inner conductor, an outer conductor surrounding the dielectric, and a jacket surrounding the outer conductor and used for coupling an end of a coaxial cable to an equipment connection port. The coaxial cable may include a coupler, a body, a post, and a biasing ring. The coupler may be adapted to couple the coaxial cable connector to the equipment connection port. At least one of the coupler, the post, and the body has a contacting portion is formed monolithically with at least one of the coupler, the post, and the body to establish electrical continuity between at least two of the coupler, the body and the post. The biasing ring biases the contacting portion such that the electrical continuity is maintained regardless of the tightness of the coupling of the connector to the terminal.

In yet another aspect, embodiments disclosed herein include a coaxial cable connector having an inner conductor, a dielectric surrounding the inner conductor, an outer conductor surrounding the dielectric, and a jacket surrounding the outer conductor and used for coupling an end of a coaxial cable to an equipment connection port. The coaxial cable comprises a coupler, a body, a post, a biasing ring and a retainer. The retainer comprises contacting portion. The contacting portion is of monolithic construction with the retainer. The biasing ring biases the contacting portion to the coupler such that the electrical continuity is maintained regardless of the tightness of the coupling of the connector to the terminal.

Additional features and advantages are set out in the detailed description which follows, and in part will be readily apparent to those skilled in the art from that description or recognized by practicing the embodiments as described herein, including the detailed description, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a side cross sectional view of a coaxial cable connector;

FIG. 2 is a side, cross sectional view of an exemplary embodiment of a coaxial connector comprising a post with a contacting portion providing an integral RFI and grounding shield and a biasing ring;

FIG. 3 is a detail view of the biasing ring illustrated in FIG. 2;

FIGS. 4A through 4H are front and side schematic views of exemplary embodiments of the contacting portions of the post;

FIG. 5 is a cross-sectional view of an exemplary embodiment of a coaxial cable connector comprising an integral pin and a biasing ring, in the state of assembly with body having a contacting portion forming to a contour of the coupler;

FIG. 5A is a partial, detail view of the contacting portion and the biasing ring illustrated in FIG. 5;

FIG. 5B is a cross-sectional view of the coaxial cable connector illustrated in FIG. 5 in a partial state of assembly illustrating the contacting portion of the body;

FIG. 5C is a is a partial, detail view of the contacting portion and the biasing ring illustrated in FIG. 5B;

FIG. 6 is a cross-sectional view of an exemplary embodiment of a coaxial cable connector comprising an integral pin and a biasing ring, wherein the coupler rotates about a body instead of a post and the contacting portion is part of a component press fit into the body and forming to a contour of the coupler;

FIG. 6A is a partial, detail view of the contacting portion and the biasing ring illustrated in FIG. 6.

FIG. 7 is a cross sectional view of an exemplary embodiment of a coaxial cable connector comprising a post-less configuration, and a body having a contacting portion forming to a contour of the coupler and a biasing ring;

FIG. 7A is a partial, detail view of the contacting portion and the biasing ring illustrated in FIG. 7.

FIG. 8 is a cross sectional view of an exemplary embodiment of a coaxial cable connector comprising a hex crimp body and a post having a contacting portion forming to a contour of the coupler and a biasing ring;

FIG. 9 is an isometric, schematic view of the post of the coaxial cable connector of FIG. 2 wherein the post has a contacting portion in a formed state;

FIG. 10 is an isometric, cross-sectional view of the post and the coupler of the coaxial cable connector of FIG. 2 illustrating the contacting portion of the post forming to a contour of the coupler;

FIG. 11 is a cross-sectional view of an exemplary embodiment of a coaxial cable connector having a coupler with a contacting portion forming to a contour of the post and a biasing ring;

FIG. 12 is a cross-sectional view of an exemplary embodiment of a coaxial cable connector having a post with a contacting portion forming to a contour of the coupler and a biasing ring;

FIG. 13 is a cross-sectional view of an exemplary embodiment of a coaxial cable connector having a post with a contacting portion forming to a contour behind a lip in the coupler toward the rear of the coaxial cable connector and a biasing ring;

FIG. 14 is a cross-sectional view of an exemplary embodiment of a coaxial cable connector having a body with a contacting portion forming to a contour behind a lip in the coupler toward the rear of the coaxial cable connector and a biasing ring;

FIG. 15 is a partial, cross-sectional view of an exemplary embodiment of a coaxial cable connector having a post with a contacting portion forming to a contour of a coupler with an undercut having a prepared coaxial cable inserted in the coaxial cable connector and a biasing ring;

FIG. 16 is a partial, cross-sectional view of an exemplary embodiment of a coaxial cable connector having a biasing ring and a moveable post with a contacting portion wherein the post is in a forward position;

FIG. 17 is a partial cross sectional view of the coaxial cable connector of FIG. 17 with the movable post in a rearward position and the contacting portion of the movable post forming to a contour of the coupler;

FIG. 18 is a cross-sectional view of an exemplary embodiment of a coaxial cable connector comprising, a retainer, an integral pin and a biasing ring;

FIG. 19 is a cross-sectional view of the coaxial cable connector illustrated in FIG. 19 in a partial state of assembly illustrating the contacting portion of the retainer and adapted to form to a contour of the coupler;

FIG. 19A is a partial, detail view of the contacting portion and the biasing ring illustrated in FIG. 19.

FIG. 20 is a cross-sectional view of the coaxial cable connector illustrated in FIG. 19 in a partial state of successively further assembly illustrating the contacting portion of the retainer and adapted to form to a contour of the coupler; and

FIG. 21 is a cross-sectional view of the coaxial cable connector illustrated in FIG. 19 in an assembled state illustrating the contacting portion of the retainer and adapted to form to a contour of the coupler.

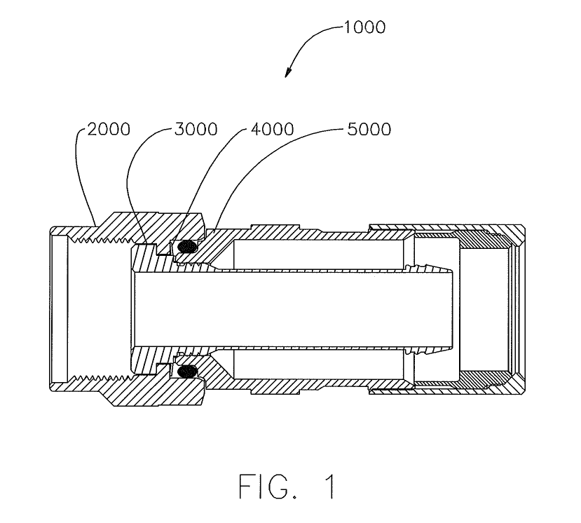

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein. Rather, these embodiments are provided so that this disclosure will satisfy applicable legal requirements. Whenever possible, like reference numbers will be used to refer to like components or parts.

For purposes of this description, the term “forward” will be used to refer to a direction toward the portion of the coaxial cable connector that attaches to a terminal, such as an appliance equipment port. The term “rearward” will be used to refer to a direction that is toward the portion of the coaxial cable connector that receives the coaxial cable. The term “terminal” will be used to refer to any type of connection medium to which the coaxial cable connector may be coupled, as examples, an appliance equipment port, any other type of connection port, or an intermediate termination device. Further, it should be understood that the term “RF shield” or “RF shielding” shall be used herein to also refer to radio frequency interference (RFI) shield or shielding and electromagnetic interference (EMI) shield or shielding, and such terms should be considered as synonymous.

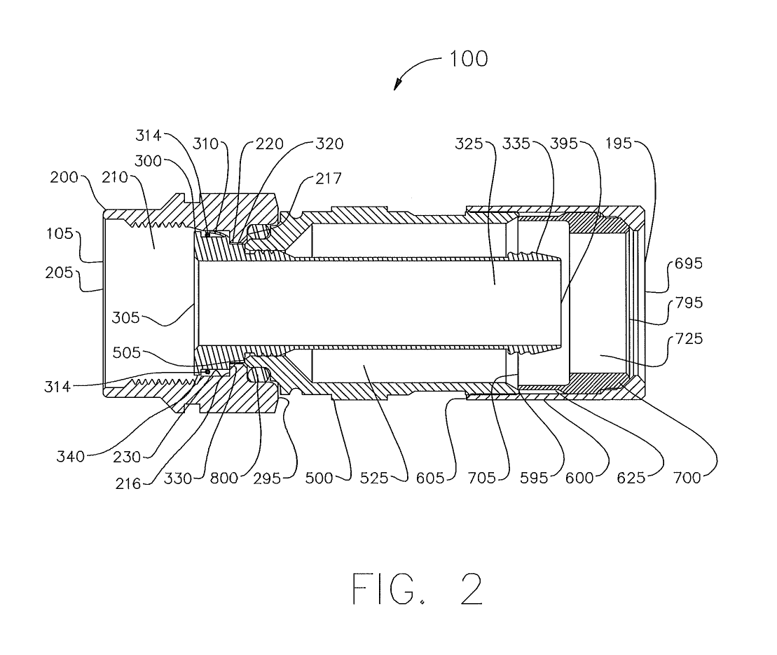

Referring now to FIG. 2, there is illustrated an exemplary embodiment of a coaxial cable connector 100. The coaxial cable connector 100 has a front end 105, a back end 195, a coupler 200, a post 300, a body 500, a shell 600 and a gripping member 700. The coupler 200 comprises a front end 205, a back end 295, a central passage 210, a lip 215 with a forward facing surface 216 and a rearward facing surface 217, a through-bore 220 formed by the lip 215, and a bore 230. Coupler 200 may be made of metal such as brass and plated with a conductive material such as nickel. Alternately or additionally, selected surfaces of the coupler 200 may be coated with conductive or non-conductive coatings or lubricants, or a combination thereof. Post 300 may be tubular and include a front end 305, a back end 395, and a contacting portion 310. In FIG. 2, contacting portion 310 is shown as a protrusion integrally formed and monolithic with post 300. Contacting portion 310 may, but does not have to be, radially projecting. Post 300 may also comprise an enlarged shoulder 340, a flange 320, a through-bore 325, a rearward facing annular surface 330, and a barbed portion 335 proximate the back end 395. The post 300 may be made of metal such as brass and plated with a conductive material such as tin. Additionally, the material, in an exemplary embodiment, may have a suitable spring characteristic permitting contacting portion 310 to be flexible, as described below. Alternately or additionally, selected surfaces of post 300 may be coated with conductive or non-conductive coatings or lubricants or a combination thereof. Contacting portion 310, as noted above, is monolithic with post 300 and provides for electrical continuity through the connector 100 to an equipment port (not shown in FIG. 2) to which connector 100 may be coupled. In this manner, post 300 provides for a stable ground path through the connector 100, and, thereby, electromagnetic or RF shielding to protect against the ingress and egress of RF signals. Electrical continuity is established through the coupler 200, the post 300, and the body other than by the use of a component unattached from or independent of the coupler 200, the post 300, and the body 500, to provide RF shielding. In this way, the integrity of an electrical signal transmitted through coaxial cable connector 100 may be maintained regardless of the tightness of the coupling of the connector 100 to the terminal. Maintaining electrical continuity and, thereby, a stable ground path, protects against the ingress of undesired or spurious radio frequency (“RF”) signals which may degrade performance of the appliance. In such a way, the integrity of the electrical signal transmitted through coaxial cable connector 100 may be maintained. This is especially applicable when the coaxial cable connector 100 is not fully tightened to the equipment connection port, either due to not being tightened upon initial installation or due to becoming loose after installation.

Body 500 comprises a front end 505, a back end 595, and a central passage 525. Body 500 may be made of metal such as brass and plated with a conductive material such as nickel. Shell 600 comprises a front end 605, a back end 695, and a central passage 625. Shell 600 may be made of metal such as brass and plated with a conductive material such as nickel. Gripping member 700 comprises a front end 705, a back end 795, and a central passage 725. Gripping member 700 may be made of a suitable polymer material such as acetal or nylon. The resin can be selected from thermoplastics characterized by good fatigue life, low moisture sensitivity, high resistance to solvents and chemicals, and good electrical properties.

In FIG. 2, coaxial cable connector 100 is shown in an unattached, uncompressed state, without a coaxial cable inserted therein. Coaxial cable connector 100 couples a prepared end of a coaxial cable to a terminal, such as a threaded female equipment appliance connection port (not shown in FIG. 2). Shell 600 slideably attaches to body 500 at back end 595 of body 500. Coupler 200 attaches to coaxial cable connector 100 at back end 295 of coupler 200. Coupler 200 may rotatably attach to front end 305 of post 300 while engaging body 500 by means of a press-fit. Front end 305 of post 300 positions in central passage 210 of coupler 200 and has a back end 395 which is adapted to extend into a coaxial cable. Proximate back end 395, post 300 has a barbed portion 335 extending radially outwardly from post 300. An enlarged shoulder 340 at front end 305 extends inside the coupler 200. Enlarged shoulder 340 comprises a collar portion 320 and a rearward facing annular surface 330. Collar portion 320 allows coupler 200 to rotate by means of a clearance fit with through-bore 220 of coupler 200. Rearward facing annular surface 330 limits forward axial movement of the coupler 200 by engaging forward facing surface 216 of lip 215. Coaxial cable connector 100 may also include a sealing ring 800 seated within coupler 200 to form a seal between coupler 200 and body 500.

Contacting portion 310 may be monolithic with or a unitized portion of post 300. As such, contacting portion 310 and post 300 or a portion of post 300 may be constructed from a single piece of material. The contacting portion 310 may contact coupler 200 at a position that is forward of forward facing surface 216 of lip 215. In this way, contacting portion 310 of post 300 provides an electrically conductive path between post 300, coupler 200 and body 500. This enables an electrically conductive path from coaxial cable through coaxial cable connector 100 to terminal providing an electrical ground and a shield against RF ingress and egress. Contacting portion 310 is formable such that as the coaxial cable connector 100 is assembled, contacting portion 310 may form to a contour of coupler 200. Assembling coupler 200 with post 300 forms contacting portion 310 in a forward direction to the contour of coupler 200. In other words, coupler 200 forms or shapes contacting portion 310 of post 300. The forming and shaping of the contacting portion 310 may have certain elastic/plastic properties based on the material of contacting portion 310. When coaxial cable connector 100 is assembled, biasing ring 314 positions inside of the coupler 200 around the post 300 and provides pressure on contacting portion 310. Additionally, when in the formed state, contacting portion 310 at least partially encloses biasing ring 314. Biasing ring 314 biases contacting portion 310 forcing the contacting portion 310 against coupler 200. Biasing ring 314 reinforces the flexible and resilient nature of contacting portion 310. Contacting portion 310 deforms, upon assembly of the components of coaxial cable connector 100, or, alternatively contacting portion 310 of post 300 may be preformed, or partially preformed to electrically contactedly fit with coupler 200. In this manner, post 300 is secured within coaxial cable connector 100, and contacting portion 310 establishes an electrically conductive path between body 500 and coupler 200. Further, the electrically conductive path remains established regardless of the tightness of the coaxial cable connector 100 on the terminal due to the elastic/plastic properties of contacting portion 310, and the biasing ring 314. This is due to contacting portion 310 maintaining mechanical and electrical contact between components, in this case, post 300 and coupler 200, notwithstanding the size of any interstice between the components of the coaxial cable connector 100. In other words, contacting portion 310 is integral to and maintains the electrically conductive path established between post 300 and coupler 200 even when the coaxial cable connector 100 is loosened or partially disconnected from the terminal, provided there is some contact of coupler 200 with equipment port.

Although coaxial connector 100 in FIG. 2 is an axial-compression type coaxial connector having a post 300, contacting portion 310 may be integral to and monolithic with any type of coaxial cable connector and any other component of a coaxial cable connector, examples of which will be discussed herein with reference to the embodiments. However, in all such exemplary embodiments, contacting portion 310 provides for electrical continuity from an outer conductor of a coaxial cable received by coaxial cable connector 100 through coaxial cable connector 100 to a terminal, without the need for a separate component. Additionally, the contacting portion 310 provides for electrical continuity regardless of how tight or loose the coupler is to the terminal.

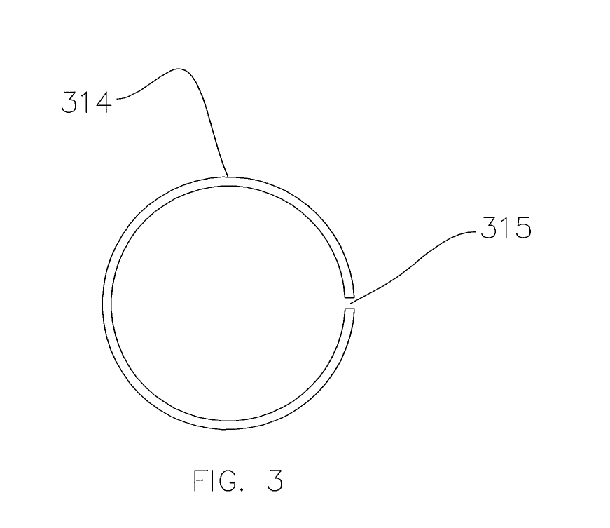

FIG. 3 provides a detail view of an embodiment of the biasing ring 314. Although not required, in FIG. 3 biasing ring 314 is shown having a slot 315. Additionally, biasing ring 314 may be constructed having any type or shape of cross section or configuration. Biasing ring 314 may be configured with slot 315 or may be contiguous. Further, biasing ring 314 and alternate configurations may be made from metal, plastic, rubber or other suitable material. Such materials may be conductive or non-conductive. Further biasing ring 314 may be coated or not coated and such coating may or may not be conductive. Biasing ring 314 may be produced by machining, molding, forming, stamping or any number of manufacturing means.

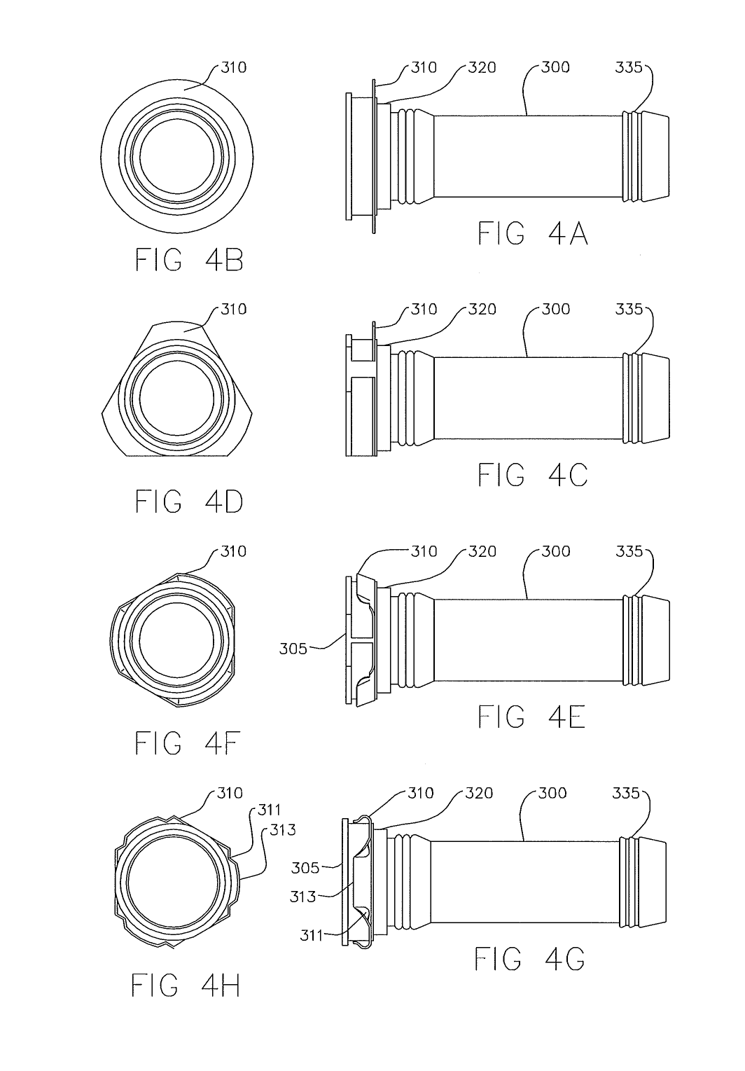

FIG. 4A is a side schematic view of an exemplary embodiment of post 300 where contacting portion 310 is a radially projecting protrusion that completely circumscribes post 300. In this view, contacting portion 310 is formable but has not yet been formed to reflect a contour of coaxial cable connector or forming tool. FIG. 4B is a front schematic view of the post 300 of FIG. 4. FIG. 4C is a side schematic view of an exemplary embodiment of post 300 where contacting portion 310 has a multi-cornered configuration. Contacting portion 310 may be a protrusion and may, but does not have to be, radially projecting. Although in FIG. 4C contacting portion 310 is shown as tri-cornered, contacting portion 310 can have any number of corner configurations, as non-limiting examples, two, three, four, or more. In FIG. 4C, contacting portion 310 may be formable but has not yet been formed to reflect a contour of coaxial cable connector or forming tool. FIG. 4D is a front schematic view of post 300 of FIG. 4C. FIG. 4E is a side schematic view of post 300 where contacting portion 310 has a tri-cornered configuration. In this view, contacting portion 310 is shown as being formed to a shape in which contacting portion 310 cants or slants toward the front end 305 of post 300. FIG. 4F is a front schematic view of post 300 of FIG. 4E. FIG. 4G is a side schematic view of an exemplary embodiment of post 300 where contacting portion 310 has a tri-cornered configuration. In this view contacting portion 310 is formed in a manner differing from FIG. 4E in that indentations 311 in contacting portion 310 results in a segmented or reduced arcuate shape 313. FIG. 4H is a front schematic view of post 300 of FIG. 4G.

It will be apparent to those skilled in the art that contacting portion 310 as illustrated in FIGS. 2-4H may be integral to and monolithic with post 300. Additionally, contacting portion 310 may have or be any shape, including shapes that may be flush or aligned with other portions of post 300, or may have any number of configurations, as non-limiting examples, configurations ranging from completely circular to multi-cornered geometries, and still perform its function of providing electrical continuity. Further, contacting portion 310 may be formable and formed to any shape or in any direction.

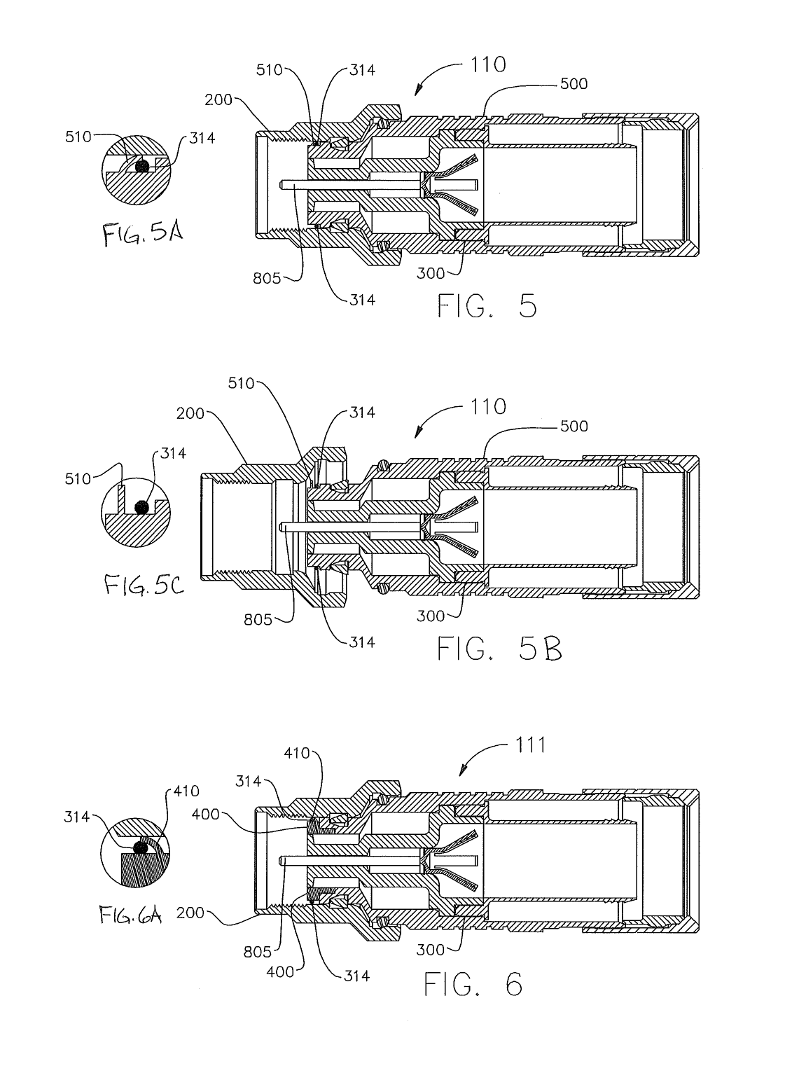

FIG. 5 is a cross-sectional view of an exemplary embodiment of a coaxial cable connector 110 comprising an integral pin 805, wherein coupler 200 rotates about body 500 instead of post 300 and contacting portion 510 is a protrusion from, integral to and monolithic with body 500 instead of post 300. In this regard, contacting portion 510 may be a unitized portion of body 500. As such, contacting portion 510 may be constructed with body 500 or a portion of body 500 from a single piece of material. When coaxial cable connector 110 is assembled, biasing ring 314 positions inside of the coupler 200 around the body 500 proximate to contacting portion 510 and biases on contacting portion 510 forcing contacting portion 510 to or against coupler 200. Coaxial cable connector 110 is configured to accept a coaxial cable.

FIG. 5A illustrates a detail of the contacting portion 510 and the biasing ring 314. Assembling coupler 200 to body 500 forms contacting portion 510 to the contour of coupler 200 in a rearward direction and at least partially encloses biasing ring 314. Biasing ring 314 reinforces the flexible and resilient nature of contacting portion 510. Contacting portion 510 remains in contact with coupler 200 independent of the tightness of the coaxial cable connector 110 on the appliance equipment connection port.

FIG. 5B is a cross-sectional view of an exemplary embodiment of a coaxial cable connector 110 in a state of partial assembly. Contacting portion 510 has not been formed to a contour of the coupler 200. Assembling the coupler 200 with the body 500 forms the contacting portion 510 in a rearward facing manner as opposed to a forward facing manner as is illustrated with the contacting portion 310. However, as with contacting portion 310, the material of contacting portion 510 has certain elastic/plastic property which, as contacting portion 510 is formed provides that contacting portion 510 will press against the contour of the coupler 200 and maintain mechanical and electrical contact with coupler 200. Contacting portion 510 provides for electrical continuity from the outer conductor of the coaxial cable to the terminal regardless of the tightness or adequacy of the coupling of the coaxial cable connector 100 to the terminal, and regardless of the tightness of the coaxial cable connector 100 on the terminal in the same way as previously described with respect to contacting portion 310. Additionally or alternatively, contacting portion 510 may be cantilevered or attached at only one end of a segment. FIG. 5C illustrates biasing ring 314 positioned in proximity with contacting portion 510 in the unformed state. Biasing ring 314 is positioned such that contacting portion 510 will at least partially enclose biasing ring 314 when the coupler 200 and body 500 are assembled allowing biasing ring 314 to bias contacting portion 510 to or against coupler 200 when connector 110 is assembled.

FIG. 6 is a cross-sectional view of an exemplary embodiment of a coaxial cable connector 111 comprising an integral pin 805, and a conductive component 400. Coupler 200 rotates about body 500 instead of about a post, which is not present in coaxial cable connector 111. Contacting portion 410 is shown as a protrusion and may be integral to, monolithically with and radially projecting from a conductive component 400 which is press fit into body 500. When coaxial cable connector 111 is assembled, biasing ring 314 positions inside of coupler 200 around the conductive component 400 proximate to contacting portion 410 and provides pressure on contacting portion 410 such that biasing ring 314 biases contacting portion 410 to or against coupler 200. Contacting portion 410 may be a unitized portion of conductive component 400. As such, the contacting portion 410 may be constructed from a single piece of material with conductive component 400 or a portion of conductive component 400. As with contacting portion 310, the material of contacting portion 410 has certain elastic/plastic property which, as contacting portion 410 is formed provides that contacting portion 410 will press against the contour of the coupler 200 and maintain mechanical and electrical contact with coupler 200 as conductive component 400 inserts in coupler 200 when assembling body 500 with coupler 200 as previously described.

FIG. 6A illustrates a detail of the contacting portion 410 and the biasing ring 314. Assembling coupler 200 with conductive component 400 forms contacting portion 410 to the contour of coupler 200 in a forward direction and at least partially encloses biasing ring 314. Biasing ring 314 biases contacting portion 410 forcing the contacting portion 410 to or against coupler 200. Biasing ring 314 reinforces the flexible and resilient nature of contacting portion 410. Contacting portion 410 remains in contact with coupler 200 independent of the tightness of the coaxial cable connector 100 on the appliance equipment connection port.

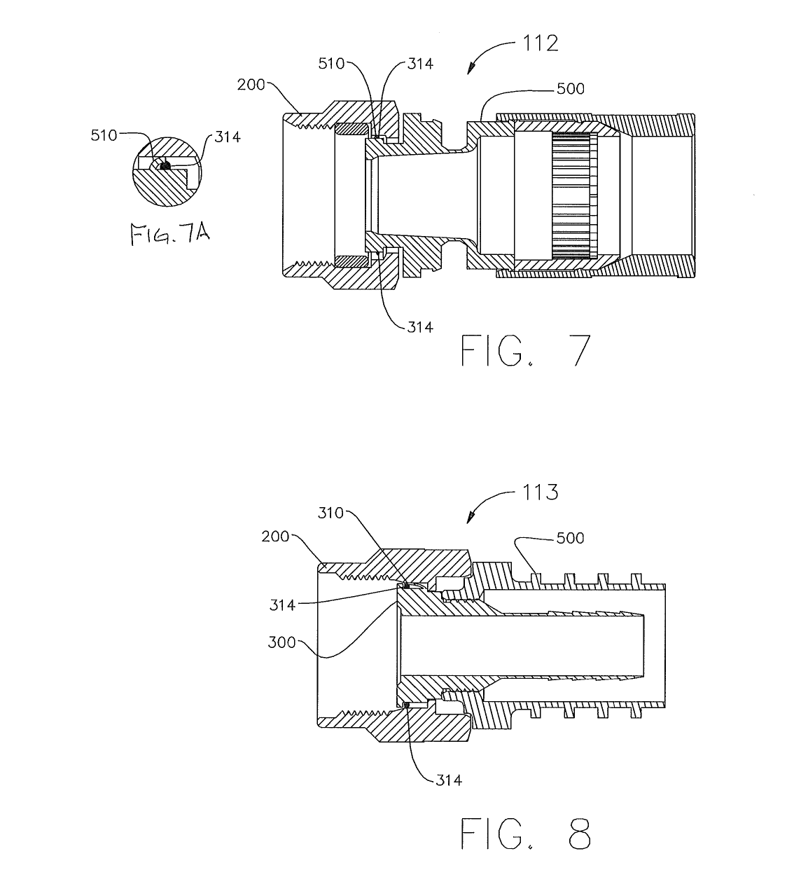

FIG. 7 is a cross-sectional view of an embodiment of a coaxial cable connector 112 that is a compression type of connector with no post. In other words, having a post-less configuration. The coupler 200 rotates about body 500 instead of a post. The body 500 comprises contacting portion 510 which is integral to and monolithic with the body 500. As such, the contacting portion 510 may be constructed from a single piece of material with the body 500 or a portion of the body 500. The contacting portion 510 forms to a contour of the coupler 200 when the coupler 200 is assembled with the body 500. Biasing ring 314 positions around the body 500 proximate to contacting portion 510 and provides pressure on contacting portion 510 such that biasing ring 314 biases contacting portion 510 forcing contacting portion 510 to or against coupler 200,

FIG. 7A illustrates a detail of the contacting portion 510 and the biasing ring 314. Assembling coupler 200 with body 500 forms contacting portion 510 to the contour of coupler 200 in a rearward direction and at least partially encloses biasing ring 314. Biasing ring 314 reinforces the flexible and resilient nature of contacting portion 510. Contacting portion 510 remains in contact with coupler 200 independent of the tightness of the coaxial cable connector 112 on the appliance equipment connection port.

FIG. 8 is a cross-sectional view of an embodiment of a coaxial cable connector 113 that is a hex-crimp type connector. The coaxial cable connector 113 comprises a coupler 200, a post 300 with a contacting portion 310 and a body 500. Biasing ring 314 positions around post 300 proximate to contacting portion 310 and biases contacting portion 310 forcing contacting portion 310 to or against coupler 200. The contacting portion 310 is integral to and monolithic with post 300. Contacting portion 310 may be unitized with post 300. As such, contacting portion 310 may be constructed from a single piece of material with post 300 or a portion of post 300. Contacting portion 310 forms to a contour of coupler 200 in a forward direction and at least partially encloses biasing ring 314 when coupler 200 is assembled with body 500 and post 300. The coaxial cable connector 113 attaches to a coaxial cable by means radially compressing body 500 with a tool or tools known in the industry.

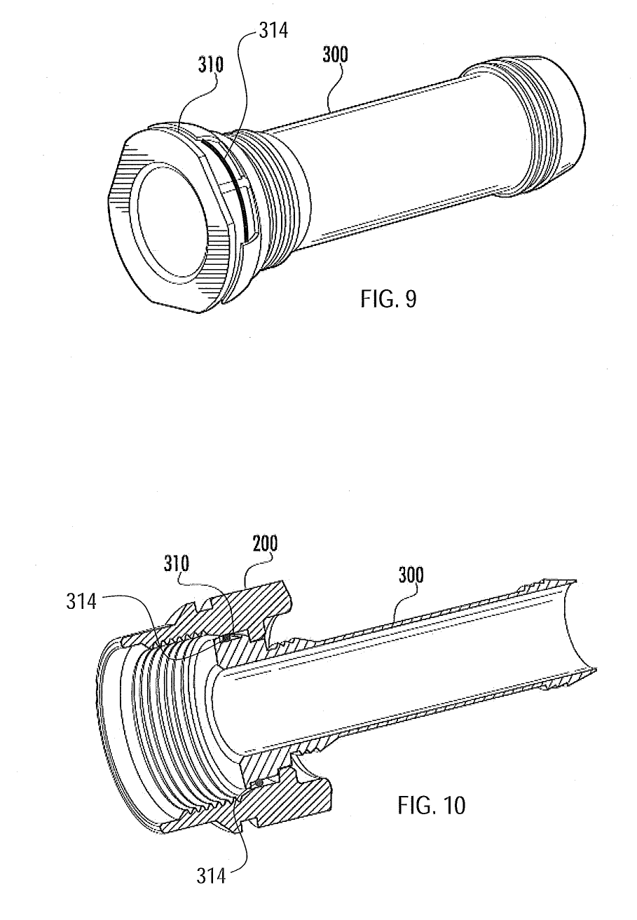

FIG. 9 is an isometric schematic view of post 300 of coaxial cable connector 100 in FIG. 2 with the contacting portion 310 formed to a position of a contour of a coupler (not shown) and biasing ring 314 positioned around post 300.

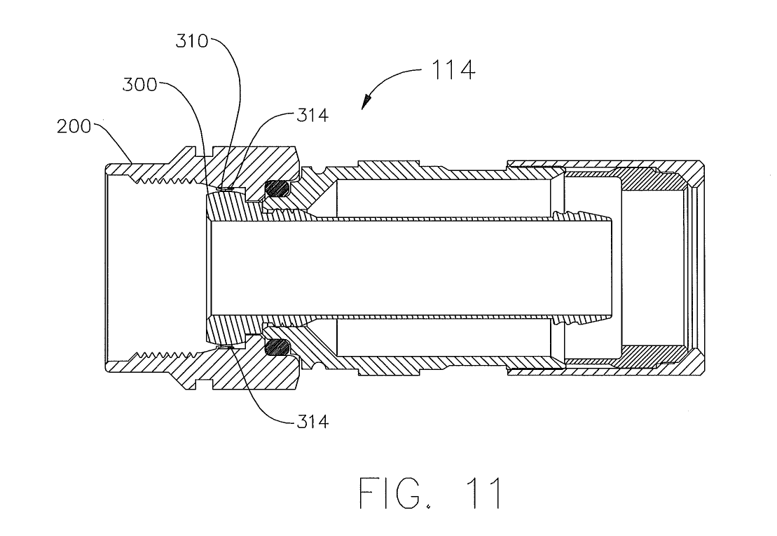

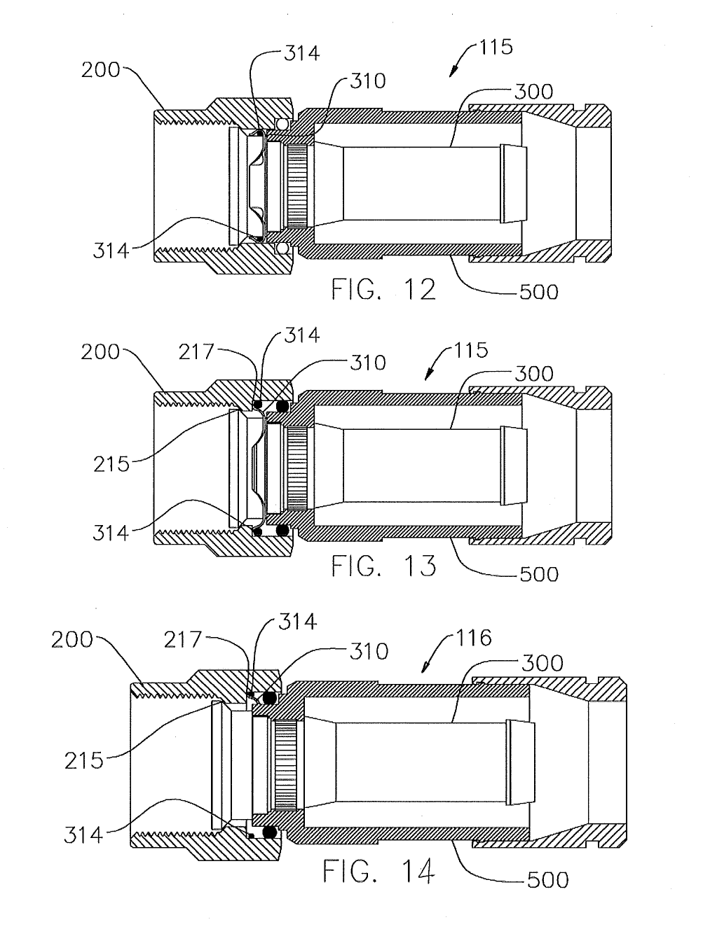

FIG. 10 is an isometric cross sectional view of post 300 and coupler 200 of connector 100 in FIG. 2 illustrated assembled with the post 300. The contacting portion 310 is formed to a contour of the coupler 200 in a forward direction and at least partially encloses biasing ring 314.

FIG. 11 is a cross-sectional view of an embodiment of a coaxial cable connector 114 comprising a post 300 and a coupler 200 having a contacting portion 210. Contacting portion 210 is shown as an inwardly directed protrusion. Contacting portion 210 is integral to and monolithic with coupler 200 and forms to a contour of post 300 in a rearward direction when post 300 assembles with coupler 200 and at least partially encloses biasing ring 314. When coaxial cable connector 114 is assembled, biasing ring 314 positions inside of coupler 200 and around post 300 proximate to contacting portion 210 biasing contacting portion 210 forcing the contacting portion 210 to or against post 300. Contacting portion 210 may be unitized with coupler 200. As such, contacting portion 210 may be constructed from a single piece of material with coupler 200 or a portion of coupler 200. Contacting portion 210 provides for electrical continuity from the outer conductor of the coaxial cable to the terminal regardless of the tightness or adequacy of the coupling of the coaxial cable connector 114 to the terminal, and regardless of the tightness of coaxial cable connector 114 on the terminal. Contacting portion 210 may have or be any shape, including shapes that may be flush or aligned with other portions of coupler 200, or may have or be formed to any number of configurations, as non-limiting examples, configurations ranging from completely circular to multi-cornered geometries.

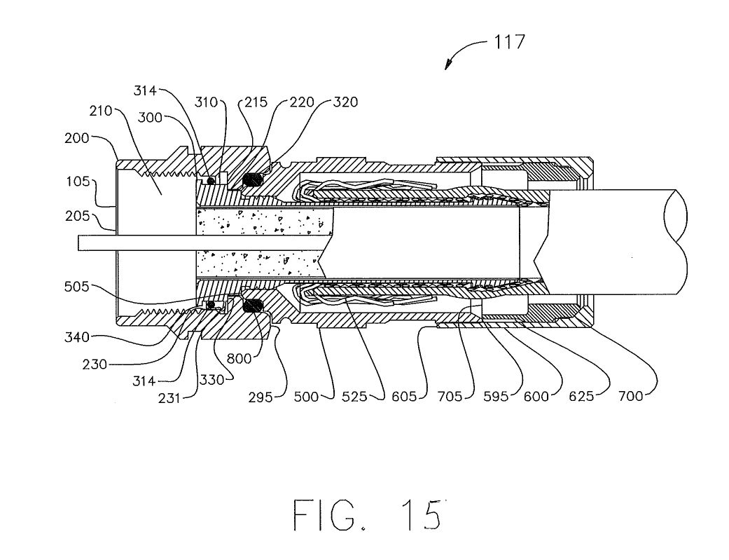

FIGS. 12 and 13 are cross-sectional views of embodiments of coaxial cable connectors 115 with a post similar to post 300 comprising a contacting portion 310 as described above such that the contacting portion 310 is shown as outwardly radially projecting, which forms to a contour of the coupler 200 at different locations of the coupler 200. Additionally, the contacting portion 310 may contact the coupler 200 rearward of the lip 215, for example as shown in FIG. 13, which may be at the rearward facing surface 217 of the lip 215. When coaxial cable connectors 115 is assembled, biasing ring 314 positions inside of coupler 200 proximate to contacting portion 310 and biases contacting portion 310 forcing contacting portion 310 to or against coupler 200,

FIG. 14 is a cross-sectional view of an embodiment of a coaxial cable connector 116 with a body 500 comprising a contacting portion 310, wherein the contacting portion 310 is shown as an outwardly directed protrusion from body 500 that forms to the coupler 200. When coaxial cable connector 116 is assembled, biasing ring 314 positions inside of coupler 200 proximate to contacting portion 310 and biases contacting portion 310 forcing contacting portion 310 to or against coupler 200,

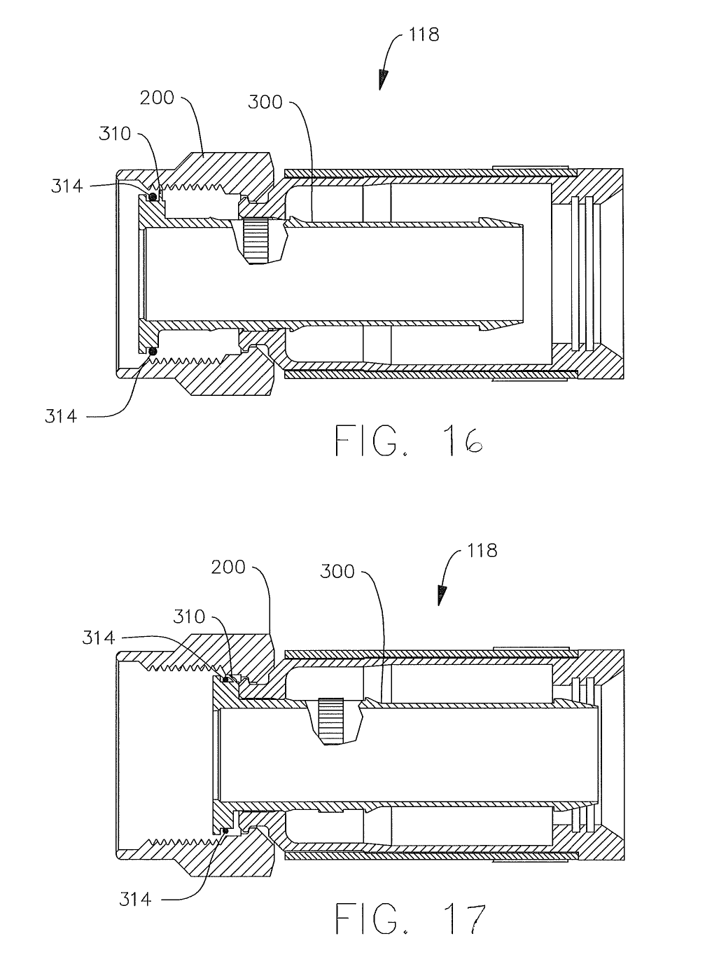

FIG. 15 is a cross-sectional view of an embodiment of a coaxial cable connector 117 having a post 300 with an integral contacting portion 310 and a coupler 200 with an undercut 231. The contacting portion 310 is shown as a protrusion that forms to the contours of coupler 200 at the position of undercut 231. When coaxial cable connector 117 is assembled, biasing ring 314 positions inside of coupler 200 around post 300 proximate to contacting portion 310 and biases contacting portion 310 forcing contacting portion 310 to or against coupler 200. In FIG. 15 the coaxial cable connector 117 having a prepared coaxial cable is shown inserted in the coaxial cable connector 117. The body 500 and the post 300 receive the coaxial cable. The post 300 at the back end 395 is inserted between an outer conductor and a dielectric layer of the coaxial cable.

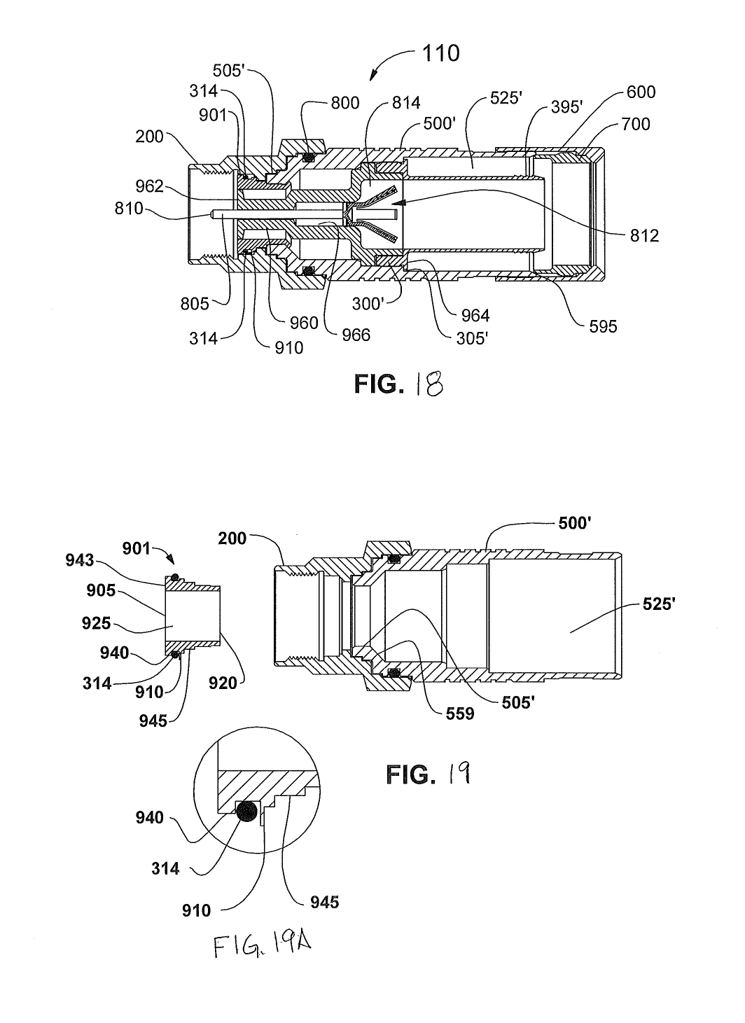

FIG. 16 is a partial, cross-sectional view of an embodiment of a coaxial cable connector 118 having a post 301 comprising an integral contacting portion 310. The movable post 301 is shown in a forward position with the contacting portion 310 not formed by a contour of the coupler 200. Biasing ring 314 positions inside of coupler 200 proximate to contacting portion 310. FIG. 17 is a partial, cross-sectional view of the coaxial cable connector 118 shown in FIG. 16 with the post 300 in a rearward position and the contacting portion 310 forming to a contour of the coupler 200. Contacting portion 210 is integral to and monolithic with post 300 and forms to a contour of coupler 200 in a rearward direction when post 300 assembles with coupler 200 and at least partially encloses biasing ring 314. Biasing ring 314 provides pressure on contacting portion 310 such that biasing ring 314 biases or forces contacting portion 310 to or against coupler 200.

Referring now to FIG. 18, an exemplary embodiment of a coaxial cable connector 110 configured to accept a coaxial cable and comprising an integral pin 805 is illustrated. The coaxial cable connector 110 has a coupler 200, which rotates about body 500′, and retainer 901. Coaxial cable connector 110 may include post 300′, O-ring 800, insulating member 960, shell 600, and deformable gripping member 700. O-ring 800 may be made from a rubber-like material, such as EPDM (Ethylene Propylene Diene Monomer). Body 500′ has front end 505′, back end 595′, and a central passage 525′ and may be made from a metallic material, such as brass, and plated with a conductive, corrosion resistant material, such as nickel. Insulating member 960 includes a front end 962, a back end 964, and an opening 966 between the front and rear ends and may be made of an insulative plastic material, such as high-density polyethylene or acetal. At least a portion of back end 964 of insulating member 960 is in contact with at least a portion of post 300′. Post 300′ includes front end 305′ and rear end 395′ and may be made from a metallic material, such as brass, and may be plated with a conductive, corrosion resistant material, such as tin. Deformable gripping member 700 may be disposed within the longitudinal opening of shell 600 and may be made of an insulative plastic material, such as high-density polyethylene or acetal. Pin 805 has front end 810, back end 812, and flared portion 814 at its back end 812 to assist in guiding an inner conductor of a coaxial cable into physical and electrical contact with pin 805. Pin 805 is inserted into and substantially along opening 966 of insulating member 960 and may be made from a metallic material, such as brass, and may be plated with a conductive, corrosion resistant material, such as tin. Pin 805 and insulating member 960 are rotatable together relative to body 500′ and post 300′.

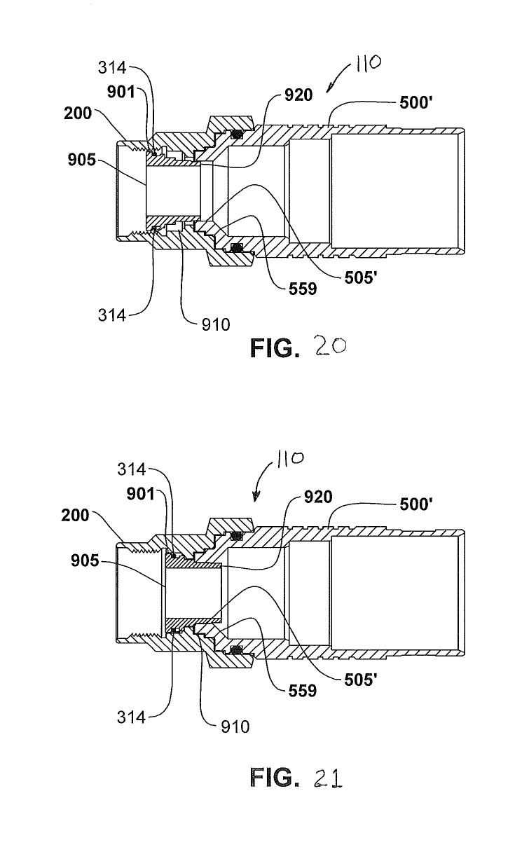

Referring also now to FIG. 19, retainer 901 may be tubular and comprise a front end 905, a back end 920, and a contacting portion 910. Contacting portion 910 may be in the form of a protrusion extending from retainer 901. Contacting portion 910 may, but does not have to be, radially projecting. Contacting portion may be integral to and monolithic with retainer 901. In this regard, contacting portion 910 may be a unitized portion of retainer 901. As such, contacting portion 910 may be constructed with retainer 901 from a single piece of material. The retainer 901 may be made of metal such as brass and plated with a conductive material such as tin. Biasing ring 314 positions around the retainer 901 in proximity to contacting portion 910. Retainer 901 may also comprise an enlarged shoulder 940, flange 943, collar portion 945, and a through-bore 925. Contacting portion 910 may be formed to a contour of coupler 200 as retainer 901 is assembled with body 500 as illustrated in FIGS. 20 and 21.

Continuing with reference to FIG. 19, there is shown a cross-sectional view of the coaxial cable connector 110 partially assembled with body 500′ engaged with coupler 200 but with retainer 901 separate therefrom. In other words, in FIG. 19, retainer 901 is shown as not yet being inserted in coupler 200. Since retainer 901 is not inserted in coupler 200, contacting portion 910 has not yet been formed to a contour of the coupler 200. However, contacting portion 910 may be adapted to form to a contour of coupler 200. FIG. 19A shows a partial, cross-sectional detail view of the contacting portion 910 in an unformed state with the biasing ring 314 positioned around retainer 901 between enlarged shoulder 940 and contacting portion 910.

FIG. 20 illustrates coaxial cable connector 110 in a further partial state assembly than as illustrated in FIG. 19 with retainer 901 partially inserted in coupler 200. In FIG. 20, contacting portion 910 is shown as beginning to form to a contour of coupler 200 in a forward direction and at least partially encloses biasing ring 314. Assembling the retainer 901 with coupler 200 and body 500′ continues forming the contacting portion 910 in a manner similar to embodiments having a post with a contacting portion 310 as previously described. As with contacting portion 310, the material of contacting portion 910 has certain elastic/plastic property which, as contacting portion 910 is formed, provides that contacting portion 910 may press against or be biased toward the contour of coupler 200 and, thereby, contacting portion 910 may maintain mechanical and electrical contact with coupler 200. When coaxial cable connector 110 is assembled, biasing ring 314 positions inside of coupler 200 and biases contacting portion 910 forcing the contacting portion 910 to or against coupler 200. In this way, contacting portion 910 provides for electrical continuity through itself, and coupler 200 and body 500′ from the outer conductor of the coaxial cable to the terminal regardless of the tightness or adequacy of the coupling of the coaxial cable connector 110 to the terminal, and regardless of the tightness of the coaxial cable connector 110 on the terminal, in the same way as previously described with respect to contacting portion 310. In other words, electrical continuity may be established through the coupler 200, the post 300′, the body 500′ and the retainer 901 other than by the use of a component unattached from or independent of the coupler 200, the post 300′, body 500′, and retainer 901 to provide RF shielding such that the integrity of an electrical signal transmitted through coaxial cable connector 110 is maintained regardless of the tightness of the coupling of the connector to the terminal. Maintaining electrical continuity and, thereby, a stable ground path, protects against the ingress of undesired or spurious RF signals which may degrade performance of the appliance. In such a way, the integrity of the electrical signal transmitted through coaxial cable connector 110 may be maintained. This is especially applicable when the coaxial cable connector 110 is not fully tightened to the equipment connection port, either due to not being tightened upon initial installation or due to becoming loose after installation. Contacting portion 910 may be cantilevered from or attached to retainer 910 at only one end of a segment of contacting portion 910. In FIG. 20, back end 920 of retainer 901 is not flared out. In other words, retainer 901 is shown in an un-flared condition.

FIG. 21 is an illustration coaxial cable connector 110 in a further partial state of assembly than as illustrated in FIG. 20. In FIG. 21, in addition to retainer 901 being fully inserted in coupler 200 and press fit into body 500′, back end 920 of retainer 901 is shown as flared within contours 559 of body 500′. In other words, retainer 901 is shown in a flared condition. Flaring of back end 920 secures retainer 901 within body 500′. It will be apparent to those skilled in the art that the contacting portion 910 as illustrated in FIGS. 18-21 may be integral to the retainer 901 or may be attached to or be part of another component. Additionally, the contacting portion 910 may have or be any shape, including shapes that may be flush or aligned with other portions of the body 500′ or another component, or may have any number of configurations, as non-limiting examples, configurations ranging from completely circular to multi-cornered geometries.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims.

It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A coaxial cable connector for coupling an end of a coaxial cable to a terminal, the coaxial cable comprising an inner conductor, a dielectric surrounding the inner conductor, an outer conductor surrounding the dielectric, and a jacket surrounding the outer conductor, the connector comprising:
a coupler adapted to couple the connector to the terminal;
a body assembled with the coupler;
a post assembled with the coupler and the body, wherein the post is adapted to receive an end of a coaxial cable; and
a biasing ring positioned inside of the coupler,
wherein at least one of the coupler, the post, and the body has a contacting portion to establish electrical continuity between at least two of the coupler, the body and the post, and wherein the contacting portion is formed monolithically with the at least one of the coupler, the post, and the body, and wherein the biasing ring biases the contacting portion such that electrical continuity is maintained regardless of the tightness of the coupling of the connector to the terminal.

2. The coaxial cable connector of claim 1, wherein the contacting portion is a radially projecting.

3. The coaxial cable connector of claim 2, wherein the contacting portion at least partially encloses the biasing ring when the coaxial cable connector is assembled.

4. The coaxial cable connector of claim 2, wherein the contacting portion forms in a rearward facing manner when the coaxial cable connector is assembled.

5. The coaxial cable connector of claim 2, wherein the contacting portion forms in a forward facing manner when the coaxial cable connector is assembled.

6. The coaxial cable connector of claim 1, wherein the contacting portion provides for electrical continuity from the outer conductor of the coaxial cable to the terminal regardless of the tightness or adequacy of the coupling of the coaxial cable connector to the terminal.

7. The coaxial cable connector of claim 1, wherein biasing ring is constructed at least partially from conductive material.

8. A coaxial cable connector for coupling an end of a coaxial cable to an equipment connection port, the coaxial cable comprising an inner conductor, a dielectric surrounding the inner conductor, an outer conductor surrounding the dielectric, and a jacket surrounding the outer conductor, the connector comprising:
a coupler adapted to couple the connector to the equipment connection port;
a body assembled with the coupler, and
a post assembled with the coupler and the body, wherein the post is adapted to receive an end of a coaxial cable;
a biasing ring, and
a retainer assembled with the coupler and the body, and wherein the retainer comprises a contacting portion, and wherein the contacting portion is of monolithic construction with the retainer, and
wherein electrical continuity is established between the retainer and the coupler, and wherein the biasing ring biases the contacting portion to the coupler such that electrical continuity is maintained regardless of the tightness of the coupling of the connector to the terminal.

9. The coaxial cable connector of claim 8, wherein the contacting portion is a radially projecting.

10. The coaxial cable connector of claim 9, wherein the contacting portion at least partially encloses the biasing ring when the coaxial cable connector is assembled.

11. The coaxial cable connector of claim 9, wherein the contacting portion forms in a forward facing manner when the coaxial cable connector is assembled.
